(19) United States
(12) Patent Application Publication
(10) Pub. No.: US 2026/0128594 A1
(43) Pub. Date: May 7, 2026

(54) SYSTEM AND METHOD FOR DYNAMIC GRID CONTROL

(71) Applicant: Georgia Tech Research Corporation, Atlanta, GA (US)

(72) Inventors: Deepak Divan, Atlanta, GA (US); Joseph Benzaquen Sune, Atlanta, GA (US); Poornachandra Rao Nallamatti, Atlanta, GA (US)

(21) Appl. No.: 19/381,870

(22) Filed: Nov. 6, 2025

Related U.S. Application Data
(60) Provisional application No. 63/717,010, filed on Nov. 6, 2024.

(51) Int. Cl. H02J 3/46; H02J 3/01; H02J 3/24

(52) U.S. Cl. CPC H02J 3/46; H02J 3/00142; H02J 3/01; H02J 2101/20

(57) ABSTRACT

An exemplary system and method are disclosed for providing a circuit that is (i) retrofittable into any power grids and (ii) operable to enhance grid performance by enabling power-flow control, voltage regulation, and impedance shaping within the power grid.

### RELATED APPLICATION

This application claims priority to, and the benefit of, U.S. Provisional Patent Application No. 63/717,010, filed Nov. 6, 2024, entitled “GRID FIRMER: CONVERTING OLTCS INTO DYNAMIC GRID CONTROL ASSETS,” which is incorporated by reference herein in its entirety.

### BACKGROUND

Current power systems are experiencing rapid growth in inverter-based resources (IBRs), such as solar, wind, and battery storage. The IBR technologies facilitate renewable integration but also introduce grid stability and reliability challenges. Current grid-following inverters perform poorly under weak grid conditions or high IBR penetration, leading to voltage instability, harmonic distortion, and reduced fault recovery capability.

Transmission and distribution networks face capacity constraints, and increasing variability in load and generation further complicates grid operation. Current standards for advanced inverter functionalities, such as grid-forming control, are evolving slowly, creating a gap between technological needs and deployment.

There is a need for a system and method that enhances grid performance while remaining compatible with current infrastructure.

### SUMMARY

An exemplary system and method are disclosed for providing a circuit that is (i) retrofittable into any power grids and (ii) operable to enhance grid performance by enabling power-flow control, voltage regulation, and impedance shaping within the power grid.

In some implementations, the system is implemented in a containerized configuration that includes a conversion circuit (also referred to as a conversion stage), operatively coupled to a transformer, comprising a converter-converter pair, a converter-inverter pair, or an inverter. The containerized configuration can (i) enable retrofitting into current power grids, (ii) provide dynamic and precise voltage control as line voltage varies, (iii) regulate power flow by inserting a quadrature voltage to increase or decrease line impedance, (iv) strengthen grid voltage to support inverter-based resources under weak-grid conditions, (v) provide damping for grid oscillations, and (vi) deliver grid voltage support to maintain system stability.

The exemplary system and method can be operatively coupled to an on-load tap changer (OLTC) to improve grid controllability and performance. In some implementations, the exemplary system and method use proven hardware, enabling retrofit into current OLTC installations on power grids and providing additional functionality for OLTC deployments. The exemplary system and method can facilitate the integration of IBRs at the grid edge, manage voltage variability and power-flow volatility, and support the deployment of low-cost renewable energy. The exemplary system and method can also be implemented with transmission or distribution transformers rated in the tens of megawatts and in medium-voltage applications, thereby enabling improved grid stability and utilization during the ongoing energy transition.

In an aspect, a system configured to couple to a power grid is disclosed comprising: a transformer (e.g., 6-8% rated transformer) having a primary winding and a secondary winding, wherein the secondary winding is operatively coupled to the power grid; a conversion circuit having a first circuit end and a second circuit end, the first circuit end being operatively coupled to the power grid, the second end being operatively coupled to the primary winding, the conversion circuit comprising: a first converter (e.g., series converter) located at the first circuit end; a second converter (e.g., shunt converter) operatively coupled to the first converter (e.g., in parallel); and a controller operatively coupled to the first converter and the second converter, the controller being configured to: receive, via the first converter, from the power grid, a first line current having a first voltage value and a first power value; inject, via the first converter, a controllable voltage (e.g., series voltage) into the first line current, to cause a change in the first voltage value and the first power value, thereby generating a second line current having a second voltage value and a second power value; adjust, via the second converter, magnitudes of the second voltage value and the second power value within operational ranges of the power grid; and transmit, via the second converter, the second line current, through the primary winding and the secondary winding, to reach the power grid.

In some embodiments, the conversion circuit further comprises: an energy storage, operatively coupled to the first converter and the second converter, the energy storage being configured to store the second line current, or power thereof.

In some embodiments, the system described herein further comprises: a fail-normal switch (FNS) configured to: in response to a line fault (e.g., inertia) or a fault inside the conversion circuit, allow the first line current to bypass the conversion circuit and reach the primary winding of the transformer.

In some embodiments, the transformer is fully rated or fractionally rated.

In some embodiments, the first converter is a series converter, and the first converter is further configured to provide a series damping for oscillations in the first line current.

In some embodiments, the second converter is a shunt converter, and the second converter is further configured to provide a shunt damping for oscillations in the second line current.

In some embodiments, the second line current has lower frequency harmonics than the first line current.

In some embodiments, the controllable voltage is a series voltage.

In some embodiments, the system described herein further comprises: an on-load tap charger (OLTC) operatively coupled to the secondary winding of the transformer and the power grid, the OLTC being configured to adjust output voltage at the secondary winding while the transformer is energized and under load.

In another aspect, a system configured to couple to a power grid is disclosed comprising: a transformer having a primary winding and a secondary winding, wherein the secondary winding is operatively coupled to the power grid and a ground; a conversion circuit having a first circuit end and a second circuit end, the first circuit end being operatively coupled to the power grid, the second end being operatively coupled to the primary winding, the conversion circuit comprising: a converter (e.g., AC-DC converter) located at the first circuit end; an inverter (e.g., PV inverter) operatively coupled to the converter; and a controller operatively coupled to the converter and the inverter, the controller being configured to: receive, via the converter, from the power grid, a first line current having a first voltage value and a first power value; inject, via the converter, a first controllable voltage (e.g., series voltage) into the first line current, to cause a change in the first voltage value and the first power value, thereby generating a second line current having a second voltage value and a second power value; inject, via the inverter, a second controllable voltage (e.g., quadrature voltage) into the second line current, to cause a change in the second voltage value and the second power value, thereby generating a third line current having a third voltage value and a third power value within operational ranges of the power grid; and transmit, via the inverter, the third line current, through the primary winding and the secondary winding, to reach the power grid.

In some embodiments, the system described herein further comprises: a fail-normal switch (FNS) configured to: in response to a line fault (e.g., inertia) or a fault inside the conversion circuit, allow the first line current or the third line current to reach a ground terminal, thereby bypassing the conversion circuit.

In some embodiments, the system described herein further comprises: an on-load tap charger (OLTC) operatively coupled to the secondary winding of the transformer and the power grid, the OLTC being configured to adjust output voltage at the secondary winding while the transformer is energized and under load.

In some embodiments, the transformer is fully rated or fractionally rated.

In some embodiments, the inverter is a photovoltaic inverter.

In some aspects, the first controllable voltage is a series voltage.

In some embodiments, the second controllable voltage is a quadrature voltage configured to be injected into each phase of each frequency harmonic within the second line current.

In yet another aspect, a system configured to couple to a power grid is disclosed comprising: a transformer having a primary winding and a secondary winding, wherein the secondary winding is operatively coupled to the power grid and a ground; a conversion circuit having a first circuit end and a second circuit end, the first circuit end being operatively coupled to the power grid, the second end being operatively coupled to the primary winding, the conversion circuit comprising: an inverter (e.g., PV inverter) located at the first circuit end; and a controller operatively coupled to the inverter, the controller being configured to: receive, via the inverter, from the power grid, a first line current having a first voltage value and a first power value; inject, via the inverter, a controllable voltage (e.g., quadrature voltage) into the first line current, to cause a change in the first voltage value and the first power value, thereby generating a second line current having a second voltage value and a second power value within operational ranges of the power grid; and transmit, via the inverter, the second line current, through the primary winding and the secondary winding, to reach the power grid.

In some embodiments, the system described herein further comprises: a fail-normal switch (FNS) configured to: in response to a line fault (e.g., inertia) or a fault inside the conversion circuit, allow the first line current or the second line current to reach a ground terminal, thereby bypassing the conversion circuit.

In some embodiments, the system described herein further comprises: an on-load tap charger (OLTC) operatively coupled to the secondary winding of the transformer and the power grid, the OLTC being configured to adjust output voltage at the secondary winding while the transformer is energized and under load.

In some embodiments, the inverter is a photovoltaic inverter.

### BRIEF DESCRIPTION OF DRAWINGS

FIGS. 1A-1D each shows an example dynamic grid control system configured to be retrofitted into current power grids and to regulate dynamic voltage, control power flow, and reduce harmonics in the current power grids, in accordance with an illustrative embodiment.

FIGS. 2A-2C each shows an example operation flow of the exemplary system, in accordance with an illustrative embodiment.

FIG. 3A shows an example converter-converter-based system, and an equivalent circuit thereof, for dynamic grid control, in accordance with an illustrative embodiment. FIG. 3B shows an example vector diagram demonstrating a series voltage injection by a series converter of the exemplary system into a line current of a power grid. FIG. 3C shows a triple-winding implementation for some current transformers. FIG. 3D shows a neutral-accessible implementation for the transformer of the exemplary system.

FIG. 4A shows an example converter-inverter-based system for dynamic grid control, in accordance with an illustrative embodiment. FIG. 4B shows example waveforms under in-phase injection and quadrature injection.

FIG. 4C shows an example inverter-based system for dynamic grid control, in accordance with an illustrative embodiment. FIG. 4D shows an equivalent circuit for the exemplary inverter-based system and vector diagrams showing voltage injection by the inverter of the exemplary system.

FIG. 4E shows an example On-Load Tap Charger (OLTC) with a plurality of tap switching devices.

FIGS. 5A-5M show a setup and evaluation of an experimental converter-converter-based system for dynamic grid control (also referred to as a first experimental system).

FIGS. 6A-6F show a setup and evaluation of an experimental inverter-based system for dynamic grid control (also referred to as a second experimental system).

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference were individually incorporated by reference.

### Example System

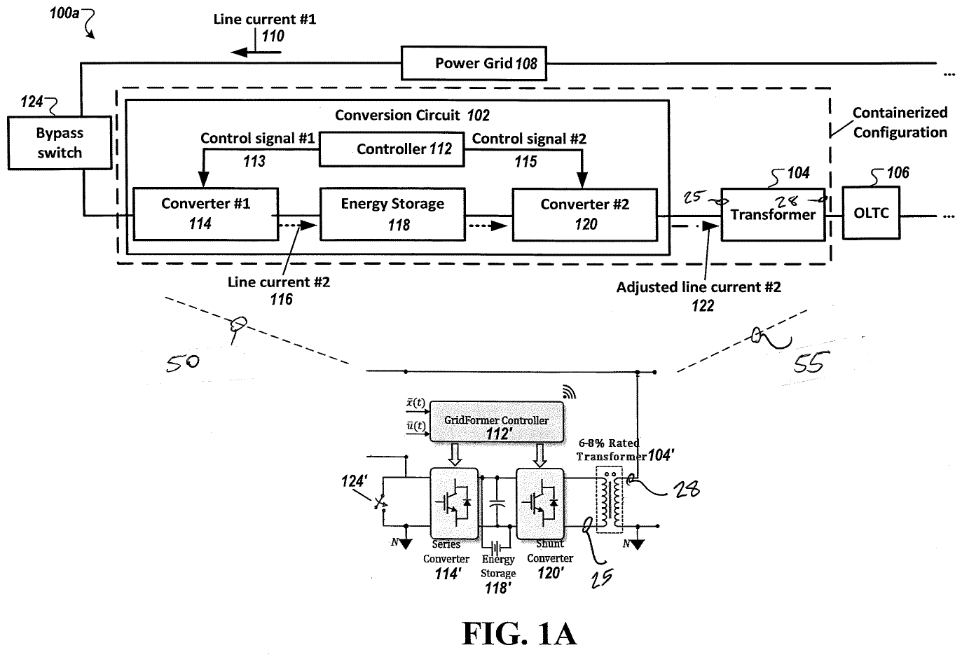

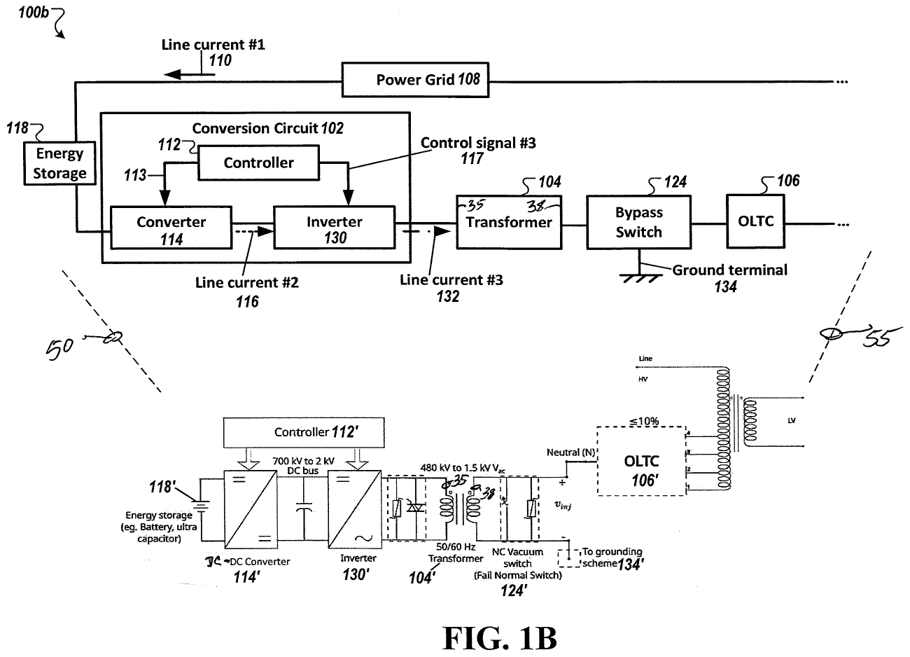

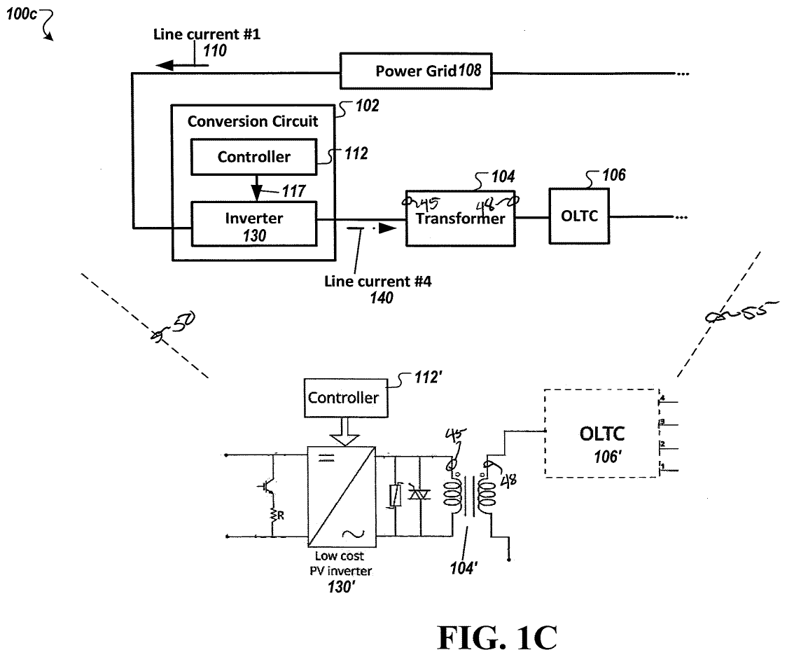

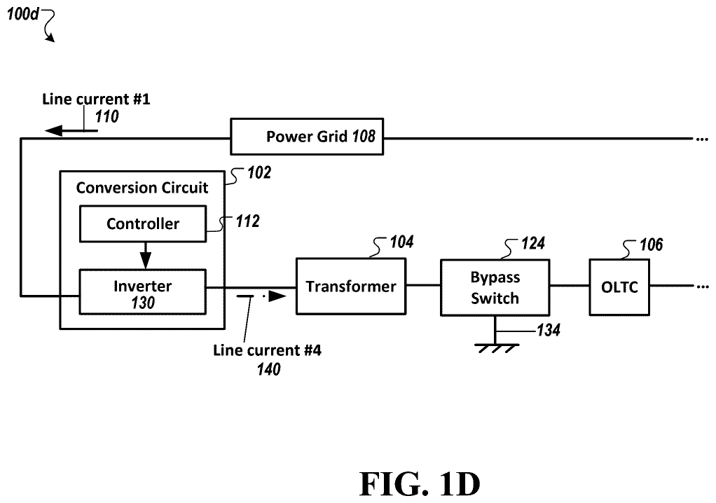

FIGS. 1A-1D each shows an example dynamic grid control system 100 (shown as 100a, 100b, 100c, 100d) configured to be retrofitted into current power grids and to regulate dynamic voltage, control power flow, and reduce harmonics in the current power grids, in accordance with an illustrative embodiment. The exemplary system 100 includes, in a containerized configuration, at least a conversion circuit 102 and a transformer 104, which allows the exemplary system 100 to be retrofitted into, or operatively coupled with, any power grids 108. In FIG. 1A, the exemplary system 100a includes a bypass switch 124 (e.g., a fail-normal switch), and the conversion circuit 102 includes a converter 114 (shown as converter #1), an energy storage 118, and a converter 120 (shown as converter #2). In FIG. 1B, the exemplary system 100b includes a bypass switch 124, and the conversion circuit 102 includes the converter 114 and an inverter 130. In FIG. 1C, the conversion circuit 102 includes the inverter 130 and no converters. In FIG. 1D, the exemplary system 100d includes a bypass switch 124, and the conversion circuit 102 includes the inverter 130 and no converters.

Conversion Circuit (102). In the example shown in FIG. 1A, the conversion circuit 102 (also referred to as a conversion stage circuit) includes a controller 112 (also shown as 112′), a converter 114 (e.g., a series converter) (also shown as 114′), an energy storage 118 (e.g., a battery, a superconductor) (also shown as 118′), and a converter 120 (e.g., a shunt converter) (also shown as 120′). In some embodiments, the converter 118 and the converter 120 are operatively connected in parallel. In some embodiments, the controller 112 is (i) operatively coupled to the converters 114 and 120 and (ii) configured to control, via a control signal 113 (shown as control signal #1), the converter 114, and control, via a control signal 115 (shown as control signal #2), the converter 120.

The converter 114, under the control (e.g., via the control signal 113) of the controller 112, is configured to (i) receive, from the power grid 108, a line current 110 (shown as line current #1) with a first voltage value and a first power value, and (ii) inject a converter-based controllable voltage (e.g., series voltage) into the line current 110, to cause a change in the first voltage value and power value, resulting in a line current 116 (shown as line current #2), as an output of the converter 114, with a second voltage value and a second power value. In some embodiments, the line current 116 has lower frequency harmonics than the line current 110.

The energy storage 118, operatively coupled to the converters 114 and 120, is configured to (i) store the line current 116, and associated voltage and power, and (ii) transmit the line current 116 to the converter 120.

The converter 120, under the control (e.g., via the control signal 115) of the controller 112, is configured to (i) receive the line current 116 (e.g., from the energy storage 118), and (ii) adjust the second voltage value and/or the second power value of the line current 116 to be within operational ranges of the power grid 108, resulting in an adjusted line current 122 (shown as adjusted line current #2), as an output of the converter 120. The converter 120 is then configured to transmit the adjusted line current 122 to the transformer 104 (also shown as 104′), where the adjusted line current may flow through the transformer's primary and secondary windings, to reach the power grid 108, or an OLTC 106 on the power grid 108.

In some embodiments, the converter 114 is a series converter configured to (i) inject a controllable series voltage (e.g., 8-10% of a grid-line-neutral voltage) into the line current 110, and (ii) provide a series damping for oscillation in the line current 110. In some embodiments, the converter 120 is a shunt converter configured to adjust the voltage and power values of the line current 116 by (i) injecting a shunt voltage into the line current 116 and (ii) providing a shunt damping for oscillations in the line current 116.

In the example shown in FIG. 1B, the conversion circuit 102 includes the controller 112 (also shown as 112′), the converter 114 (e.g., a series AC-DC converter) (also shown as 114′), and an inverter 130 (e.g., a photovoltaic (PV) converter) (also shown as 130′). In some embodiments, the controller 112 is (i) operatively coupled to the converter 114 and the inverter 130, and (ii) configured to control, via the control signal 113, the converter 114, and control, via a control signal 117 (shown as control signal #3), the inverter 130.

The inverter 130, under the control (e.g., via the control signal 117) of the controller 112, is configured to (i) receive the line current 116 (e.g., from the converter 114), and (ii) inject an inverter-based controllable voltage (e.g., quadrature voltage) into the line current 116, to cause a change in the second voltage value and/or the second power value of the current line 116, resulting in a line current 132 (shown as line current #3), as an output of the inverter 130, with a third voltage value and a third power value within the operational ranges of the power grid 108. The inverter 130 is then configured to transmit the line current 132 to the transformer 104 (also shown as 104′), where the line current 132 may flow through the transformer's primary and secondary windings, to reach the power grid 108, or the OLTC 106 on the power grid 108.

In some embodiments, the inverter 130 is a photovoltaic (PV) inverter. In some embodiments, the inverter-based controllable voltage is a quadrature voltage that the inverter 130 injects into each phase of each frequency harmonic within the line current 116.

In the examples shown in FIGS. 1C-1D, the conversion circuit 102 includes the controller 112 (also shown as 112′), the inverter 130 (also shown as 130′), and no converters (e.g., 114, 120). In some embodiments, the controller 112 is (i) operatively coupled to the inverter 130, and (ii) configured to control, via the control signal 117, the inverter 130.

The inverter 130, under the control (e.g., via the control signal 117) of the controller 112, is configured to (i) receive the line current 110 (e.g., from the power grid 108), and (ii) inject the inverter-based controllable voltage into the line current 110, to cause a change in the first voltage value and the first power value of the line current 110, resulting in a line current 140 (shown as line current #4), as an output of the inverter 130, with a fourth voltage value and a fourth power value within the operational ranges of the power grid 108. The inverter 130 is then configured to transmit the line current 140 to the transformer 104 (also shown as 104′), where the line current 140 may flow through the transformer's primary and secondary windings, to reach the power grid 108, or the OLTC 106 on the power grid 108.

Transformer (104). In the examples shown in FIGS. 1A-1D, the transformer 104 (e.g., 6-8% impedance rate), a fully rated or fractionally rated transformer, includes a primary winding and a secondary winding. In some embodiments, the primary winding of the transformer 104 is electrically or operatively connected to a converter (e.g., 120) or an inverter (e.g., 130) of the conversion circuit 102. In some embodiments, the secondary winding of the transformer 104 is electrically or operatively connected to the power grid 108, or the OLTC 106 on the power grid 108.

Bypass Switch (124). In the example shown in FIG. 1A, the exemplary system 100a includes a bypass switch 124 (e.g., a fail-normal switch) that is operatively coupled to the conversion circuit 102 (e.g., at a proximal end to the converter 114), on the power grid 108. In some embodiments, the bypass switch 124 is configured to (i) receive, from the power grid 108, the line current 110, and (ii) facilitate the line current 110 to bypass the conversion circuit 102 and directly reach the primary winding of the transformer 104, in response to a line fault (e.g., virtual inertia, black start) or a fault within the conversion circuit 120.

In the examples shown in FIGS. 1B and 1D, the bypass switch 124 is operatively coupled to (i) the transformer 104 (e.g., via the secondary winding), and (ii) the power grid 108 or the OLTC 106 on the power grid 108. In some embodiments, in response to a line fault or a fault within the conversion circuit 102, the bypass switch 124 is configured to facilitate the line current 110 or the line current 132 to reach a ground terminal 134, bypassing the conversion circuit 102.

On-Load Tap Charger (106). In the example shown in FIGS. 1A and 1C, the exemplary system 100a and 100c includes an on-load tap charger 106 (OLTC) that is operatively coupled to the secondary winding (e.g., via a neutral side or access) of the transformer 104 and the power grid 108.

In some embodiments, the OLTC 106 is configured with a plurality of tap switching devices, including a selector switch connected to the controller 112. In some embodiments, the OLTC is connected to a designated grid control system and/or sensors placed on the grid to manage the operation of the OLTC and maximize efficiency in power distribution according to selected parameters and sensor values being monitored. The OLTC 106 is then configured to adjust the effective turns ratio of the transformer 104 (e.g., thereby adjusting output voltage of the transformer 104) according to the designated grid control system providing control data to a selector switch connection. The conversion circuit 102 includes a separate controller 112 that may utilize data from a designated grid control system, the OLTC and/or associated sensors to assess states of the power grid in terms of power distribution parameters of interest. The controller 112 bases conversion circuit control signals (e.g., 113, 115, 117), and operation of the controller 112, on the time varying state x(t) of the grid (i.e., sensor data and monitored grid parameters accessible to the controller 112). The controller 112 also utilizes calculated input vectors u(t) requested by the controller 112 (FIG. 1A) to monitor the grid along with other inputs and saved data utilized by the controller 112 in its control algorithm. This data selection and data processing activity allows the conversion circuit 102 to inject appropriate power signals and voltage as discussed herein.

### Example Method

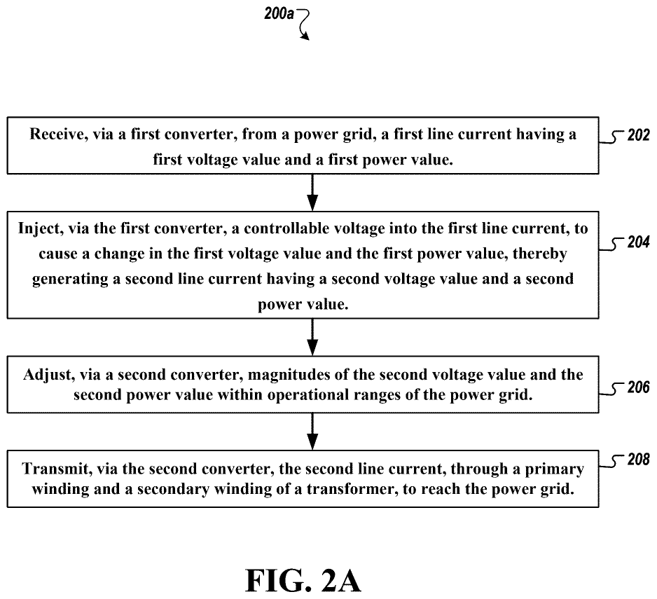

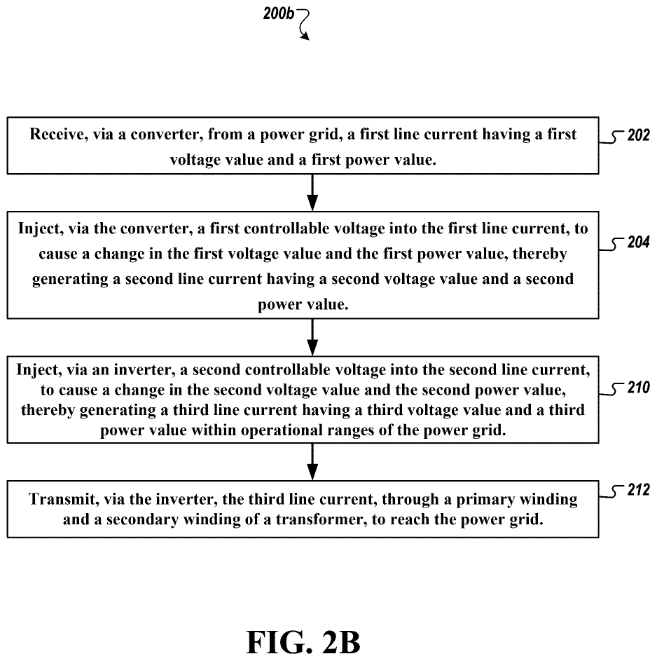

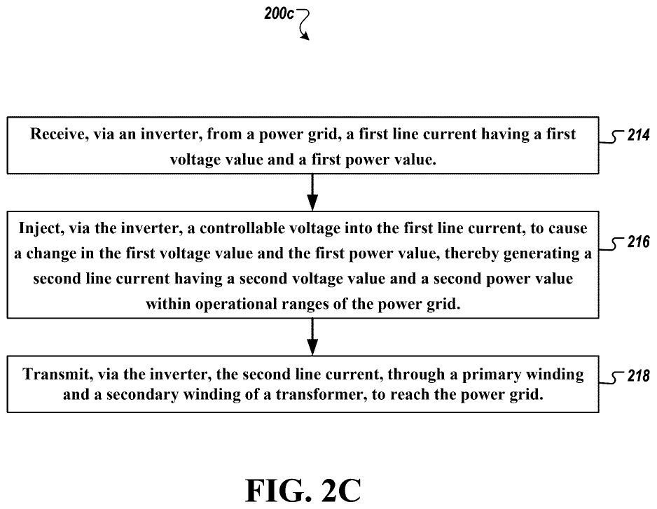

FIG. 2A shows an example operation flow 200a of the exemplary system, in accordance with an illustrative embodiment. The method 200a includes receiving (202), via a first converter (e.g., 114, FIG. 1A), from a power grid (e.g., 108, FIG. 1A), a first line current (e.g., 110, FIG. 1A) having a first voltage value and a first power value. The method 200a includes injecting (204), via the first converter (e.g., 114, FIG. 1A), a controllable voltage (e.g., converter-based controllable voltage) into the first line current (e.g., 110, FIG. 1A), to cause a change in the first voltage value and the first power value, thereby generating a second line current (e.g., 116, FIG. 1A) having a second voltage value and a second power value. The method 200a includes adjusting (206), via a second converter (e.g., 120, FIG. 1A), magnitudes of the second voltage value and the second power value within operational ranges of the power grid (e.g., 108, FIG. 1A). The method 200a includes transmitting (208), via the second converter (e.g., 120, FIG. 1A), the second line current (e.g., 116, FIG. 1A), through a primary winding and a secondary winding of a transformer (e.g., 104, FIG. 1A), to reach the power grid (e.g., 108, FIG. 1A).

In some embodiments, the transformer (e.g., 104, FIG. 1A) is fully rated or fractionally rated.

In some embodiments, the first converter (e.g., 114, FIG. 1A) is a series converter configured to (i) inject a series voltage into the first line current, and (ii) provide a series damping for oscillations in the first line current.

In some embodiments, the second converter (e.g., 120, FIG. 1A) is a shunt converter configured to adjust the voltage and power values of the line current 116 by (i) injecting a shunt voltage into the line current 116 and (ii) providing a shunt damping for oscillations in the line current 116.

In some embodiments, the second line current (e.g., 116, FIG. 1A) has lower frequency harmonics than the first line current (e.g., 110, FIG. 1A).

FIG. 2B shows an example operation flow 200b of the exemplary system, in accordance with an illustrative embodiment. The method 200b includes receiving (202), via a converter (e.g., 114, FIG. 1B), from a power grid (e.g., 108, FIG. 1B), a first line current (e.g., 110, FIG. 1B) having a first voltage value and a first power value. The method 200b includes injecting (204), via the converter (e.g., 114, FIG. 1B), a controllable voltage (e.g., converter-based controllable voltage) into the first line current (e.g., 110, FIG. 1B), to cause a change in the voltage value and the power value, thereby generating a second line current (e.g., 116, FIG. 1B) having a second voltage value and a second power value. The method 200b includes injecting (210), via an inverter, a second controllable voltage (e.g., inverter-based controllable voltage) into the second line current (e.g., 116, FIG. 1B), to cause a change in the second voltage value and the second power value, thereby generating a third line current (e.g., 132, FIG. 1B) having a third voltage value and a third power value within operational ranges of the power grid (e.g., 108, FIG. 1B). The method 200b includes transmitting (212), via the inverter (e.g., 130, FIG. 1B), the third line current (e.g., 132, FIG. 1B), through a primary winding and a secondary winding of a transformer (e.g., 104, FIG. 1B), to reach the power grid (e.g., 108, FIG. 1B).

In some embodiments, the inverter (e.g., 130, FIG. 1B) is a photovoltaic (PV) inverter.

In some embodiments, the transformer (e.g., 104, FIG. 1B) is fully rated or fractionally rated.

In some embodiments, the converter (e.g., 114, FIG. 1B) is a series converter configured to (i) inject a series voltage into the first line current, and (ii) provide a series damping for oscillations in the first line current.

In some embodiments, the first controllable voltage is a series voltage. In some embodiments, the second controllable voltage is a quadrature voltage configured to be injected into each phase of each frequency harmonic within the second line current (e.g., 116, FIG. 1B).

FIG. 2C shows an example operation flow 200c of the exemplary system, in accordance with an illustrative embodiment. The method 200c includes receiving (214), via an inverter (e.g., 130, FIGS. 1C-1D), from a power grid (e.g., 108, FIGS. 1C-1D), a first line current (e.g., 110, FIGS. 1C-1D) having a first voltage value and a first power value. The method 200c includes injecting (216), via the inverter (e.g., 130, FIGS. 1C-1D), a controllable voltage (e.g., inverter-based controllable voltage) into the first line current (e.g., 110, FIGS. 1C-1D), to cause a change in the first voltage value and the first power value, thereby generating a second line current (e.g., 140, FIGS. 1C-1D) having a second voltage value and a second power value within operational ranges of the power grid. The method 200c includes transmitting (218), via the inverter (e.g., 130, FIGS. 1C-1D), the second line current (e.g., 140, FIGS. 1C-1D), through a primary winding and a secondary winding of a transformer (e.g., 104, FIGS. 1C-1D), to reach the power grid (e.g., 108, FIGS. 1C-1D).

In some embodiments, the inverter (e.g., 130, FIGS. 1C-1D) is a photovoltaic (PV) inverter.

In some embodiments, the transformer (e.g., 104, FIGS. 1C-1D) is fully rated or fractionally rated.

In some embodiments, the controllable voltage is a quadrature voltage configured to be injected into each phase of each frequency harmonic within the first line current (e.g., 110, FIGS. 1C-1D).

### Example Converter-Converter-Based System for Dynamic Grid Control

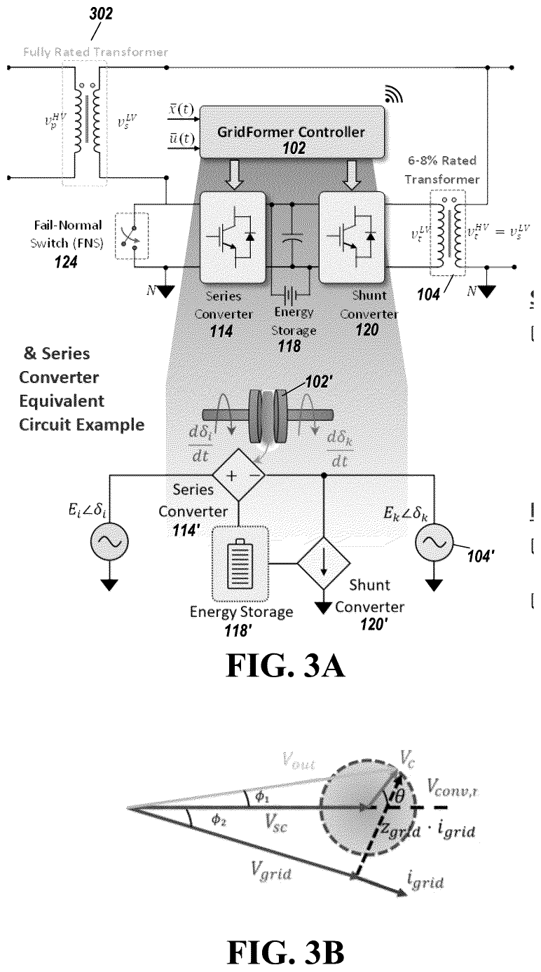

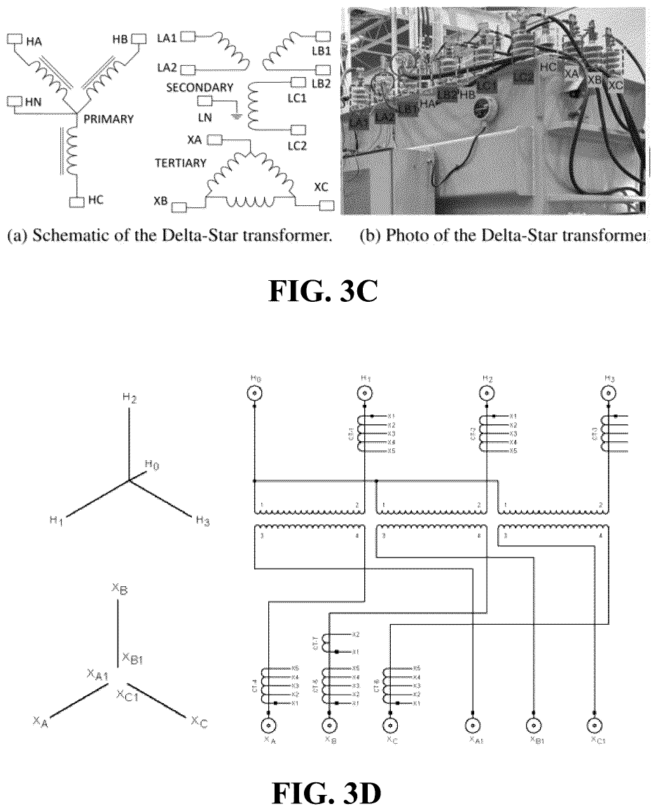

FIG. 3A shows an example converter-converter-based system (e.g., 100a, FIG. 1A), and an equivalent circuit thereof, for dynamic grid control, in accordance with an illustrative embodiment. As shown, the exemplary system includes a transformer 104 (also shown as 104′), a series converter 114 (also shown as 114′), an energy storage 118 (also shown as 118′), a shunt converter 120 (also shown as 120′), and a bypass switch 124 (e.g., a fail-normal switch).

The exemplary converter-converter-based system (e.g., fractionally rated, 8-10% impedance), in a containerized configuration with a converter pair (e.g., 114, 120) and a storage 118, can be retrofitted into any power grids (e.g., 108, FIG. 1A), or a transformer 302 thereof, to provide steady-state and transient grid support, including (i) power flow control, impedance control, voltage support, and (ii) inertia support, black start capability, series/damping functions, and grid-forming capability. The exemplary system can be deployed at any PV or wind farms, or at transmission and distribution substations, facilitating grid operators to exercise improved control over power grid operations.

In some embodiments, the series converter 114 (e.g., rated at 5-10%) is configured to inject a series voltage into a line current (e.g., 110, FIG. 1A) of the power grid (see FIG. 3B), which facilitates various grid control functions, including active and reactive power flow control, grid line impedance shaping, voltage regulation, and series damping of power system oscillations (e.g., low- and mid-frequency oscillations in grid system frequency and phase angle).

In some embodiments, the shunt converter 120 (e.g., rated at 5-10%) is configured as a controllable voltage or current source to perform various grid-support functions, including grid-forming capability, voltage support, frequency support, reactive power (VAR) compensation (e.g., power factor correction), provision of virtual inertia, and black-start capability.

In some embodiments, the fail-normal switch 124 is configured to provide a fail-normal functionality that facilitates the transformer 302 (of the power grid) to continue operating under normal conditions by bypassing the power conversion stage (e.g., 102, FIG. 1A) in the event of a failure. The fail-normal switch 124 is further configured to handle short-circuit conditions, ensuring system reliability and protection during fault events.

FIG. 3B shows an example vector diagram demonstrating a series voltage injection by a series converter (e.g., 114, FIGS. 1A and 3A) into a line current of a power grid.

Neutral-Accessible Transformer Implementation. The conversion stage (e.g., 102, FIG. 1A) of the exemplary system (e.g., 100a, FIG. 1A) should be connected in series with a winding of a transformer (e.g., 104, FIGS. 1A and 3A), preferably the low-voltage (LV) winding of the transformer.

FIG. 3C shows a triple-winding implementation for some current transformers, which requires a third winding at 8-10% LV rating and is not retrofittable. FIG. 3D shows a neutral-accessible implementation for the transformer (e.g., 104, FIGS. 1A and 3A) of the exemplary system, which facilitates the exemplary system to be fully retrofittable into any power grids. In the neutral-accessible implementation, the exemplary system may require access to six terminals of the LV winding (e.g., a three-phase transformer with six LV terminals).

### Example Converter-Inverter-Based System for Dynamic Grid Control

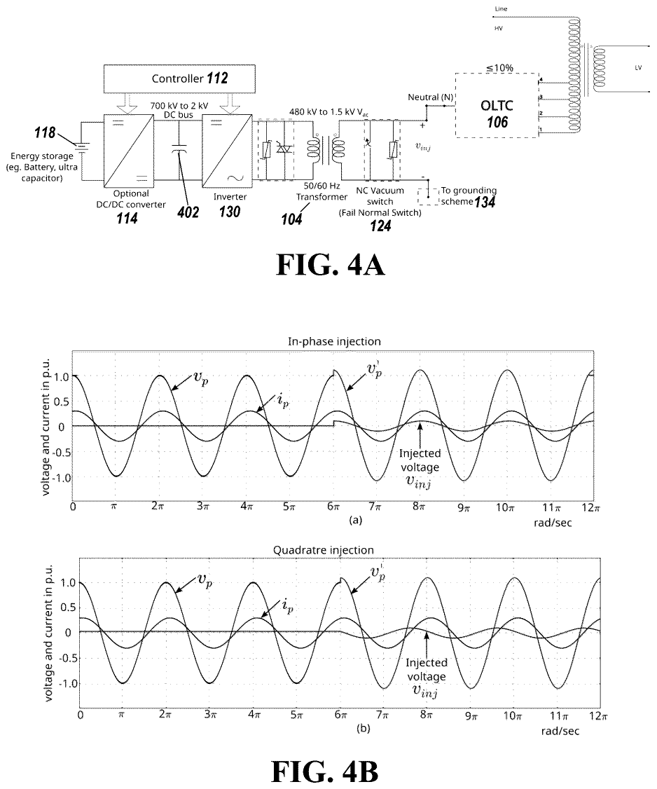

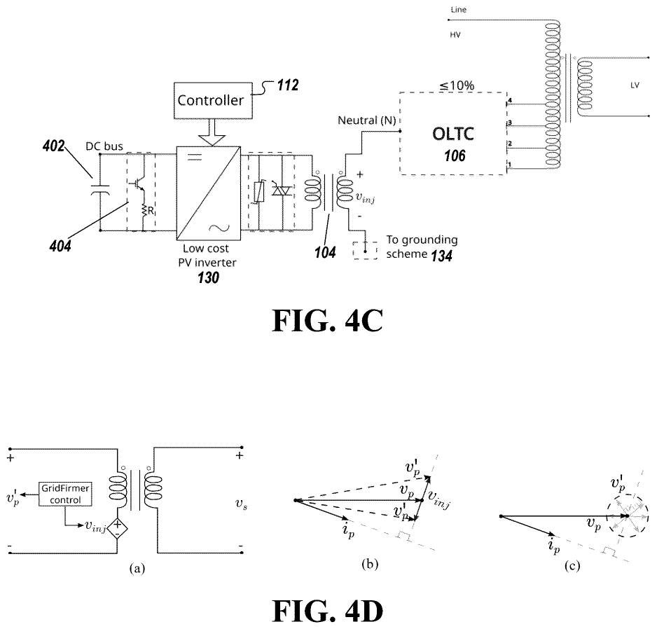

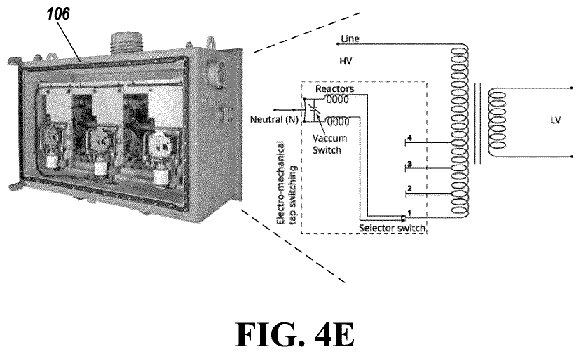

FIG. 4A shows an example converter-inverter-based system (e.g., 100b, FIG. 1B) for dynamic grid control, in accordance with an illustrative embodiment. As shown, the exemplary system, operatively connected to an on-load tap charger (OLTC) 106, includes a transformer 104, a bypass switch 124 (e.g., a fail-normal switch), an inverter 130 (e.g., DC/AC inverter), a converter 114 (e.g., DC/DC converter), and an energy storage 118 (e.g., a battery).

The OLTC 106 switches on the neutral side of the transformer connection and allows access to the per-phase neutral winding to insert the exemplary system. The exemplary system may be rated fractionally (8-10%) of the OLTC megavolt-ampere (MVA) rating. In some embodiments, the converter 114 is an Uninterruptible Power Supply (UPS) system used in data centers that may be rated at 1-5 MVA and have battery backup for 5-10 minutes to allow backup generators to ramp up if the grid is lost. UPSs may also have a bypass switch, which serves a function similar to the fail-normal switch 124 in FIG. 4A.

FIG. 4D, subpanel (a) shows the equivalent circuit of the converter-inverter-based system (shown as GridFirmer control). In FIG. 4D, subpanels (b)-(c), the exemplary system can dynamically insert a voltage in series with the power line at any phase angle.

The voltage injection, typically in the range of 8-10% of the line-neutral voltage, can provide grid support in various aspects, including (i) providing dynamic and precise voltage control as line voltage varies, (ii) reducing the number of tap-switching events to extend OLTC life, (iii) controlling power flow by inserting a quadrature voltage to increase or decrease line impedance, (iv) strengthening grid voltage to allow GFL IBRs to operate under weak-grid conditions. (v) providing damping for grid oscillations, and (vi) providing demand management at a feeder level, which is energy-storage-dependent.

For each supporting function, the voltage injection requirements may differ. Further control may be employed to balance energy flows into and out of the energy storage element. For instance, dynamic voltage control requires the ‘output’ voltage of the OLTC 106 to be maintained constant through the injection of a voltage that is in phase with the line-neutral voltage. On the other hand, power flow control requires an injected voltage in quadrature with the current in the line, resulting in an increase or decrease in line impedance based on the voltage polarity.

If sufficient stored energy is available, the exemplary system can reduce or increase the power flow onto the grid to realize demand management. Damping requires absorption of energy from the line using techniques known to one skilled in the art [3], [4]. Finally, the injected series impedance can dynamically be controlled to emulate a ‘stiff’ grid so that downstream GFL IBR resources can continue to operate, even under ‘weak-grid’ conditions.

In case of faults on the grid or within the exemplary system, the fail-normal switch (FNS) 124 may be activated to restore normal OLTC operation. The FNS 124 is rated to carry fault currents for which the OLTC 106 is rated, typically in the range of 10-100 kiloamperes. FIG. 4B shows example waveforms under: subpanel (a) in-phase injection, and subpanel (b) quadrature injection.

The exemplary converter-inverter-based system may employ a transformer selected to match the inserted voltage (8-10% of line-neutral voltage) with the voltage of the inverter 130 (e.g., DC/AC inverter). A direct current (DC) bus 402 for the inverter 130 may be in the range of 700-2000 volts DC, giving an alternating current (AC) voltage of 480 VAC to 1500 VAC. The transformer 104 allows for the matching of the ratings required for the exemplary system, the line voltage, the MVA rating of the transformer 104, and the volt-ampere (VA) rating of the inverter 130. To connect the energy storage 118 (e.g., battery, ultracapacitor energy storage) to the DC bus 402 of the inverter 130, the exemplary system may use the converter 114 (e.g., DC/DC converter). The techniques for the selection and control of DC/AC inverters for UPS-type applications are known to one skilled in the art.

### Example Inverter-Based System for Dynamic Grid Control

FIG. 4C shows an example inverter-based system (e.g., 100c, FIG. 1C; 100d, FIG. 1D) for dynamic grid control, in accordance with an illustrative embodiment. As shown, the exemplary system is configured to pair an on-load tap charger 106 (OLTC) with a photovoltaic (PV) inverter 130 (e.g., fractionally-rated (˜8% of OLTC rating) PV inverter) and a ‘fail-normal’ bypass switch (not shown), to realize unprecedented grid control capability and an ability to scale rapidly. The fail-normal switch also bypasses the inverter 130 under system fault conditions and carries the system short-circuit current. An operation of the exemplary system may rely on the insertion of the PV inverter in between the neutral wire for each phase and the system neutral/ground (e.g., to which the OLTC neutrals are connected). This may be reflected on the grid as a series voltage that the inverter injects individually into each phase, which can also be dynamically controlled.

FIG. 4D shows an equivalent circuit for the exemplary inverter-based system (shown as GridFirmer control) (subpanel (a)) and vector diagrams showing voltage injection by the inverter (subpanels (b)-(c)). Specifically, subpanel (b) shows a quadrature voltage injection into a line current by the inverter 130, and subpanel (c) shows a fractionally-rated generic voltage injection circle into a line current by the inverter 130. In a meshed or sub-transmission system, injecting a voltage in quadrature with the line current (see subpanel (b)) can provide continuous power flow control by decreasing or increasing the line impedance. The injected voltage can be controlled to reduce the harmonic current flowing in the line. The series-injected voltage can also be used to make a line or point of interconnection appear stiffer, i.e., with a higher short circuit ratio (SCR) under dynamic conditions. As a result, grid-following (GFL) inverter-based resources (IBRs) interfacing the grid with the exemplary system can improve their dynamic performance and stability margins for a given set of grid control parameters. At the same time, by adding a dynamic brake 404 on a DC-bus, the exemplary system can also provide series damping for power oscillations by absorbing energy from the grid system. In radial distribution systems, the exemplary system can also offload the switching duty of the OLTC 106, providing improved voltage regulation and extending OLTC life.

In some embodiments, an OLTC 106 (e.g., 50 MW 230 kV) located in a substation is augmented with the exemplary inverter-based system that includes a PV inverter 130 (e.g., a 4 MW PV inverter), a transformer 104, a bypass switch, and an optional dynamic brake 404. Utility concerns about the reliability of power converters on the grid can be addressed by the fail-normal switch, which allows the grid to revert to its normal mode if the exemplary system fails.

Table 1 summarizes example functions of the exemplary inverter-based system that support a power grid. As shown, the functions of the exemplary inverter-based system that support the grid may be substantially the same as those of the converter-inverter-based system.

TABLE 1
The exemplary inverter-based system can provide dynamic and
precise voltage control as line voltage varies.
The exemplary inverter-based system can reduce the number of
tap-switchings to extend OLTC life.
The exemplary inverter-based system can increase and decrease
line impedance by injecting quadrature voltage into the line
current, thereby controlling the power flow.
The exemplary inverter-based system can strengthen grid voltage
to allow GFL IBRs to operate under weak-grid conditions.
The exemplary inverter-based system can provide damping for
grid oscillations.
The exemplary inverter-based system can provide grid voltage
support.
The exemplary inverter-based system can provide demand management
at the feeder level, which is energy-storage-dependent.

### Example On-Load Tap Charger

FIG. 4E shows an example On-Load Tap Charger 106 (OLTC) having a plurality of tap switching devices (shown as electro-mechanical tap switching) (e.g., a selector switch).

In some embodiments, the OLTC 106 is operatively coupled (e.g., via a neutral side or access) to a medium-voltage/high-voltage (MV/HV) power transformer (e.g., 104, FIGS. 1A-1D) rated for 1-200 megawatts (MW) and operating at 13-345 kV in a power grid. The OLTC 106 is configured to adjust the effective turns ratio of the transformer (e.g., 104, FIGS. 1A-1D) to maintain grid stability and optimize power quality. In some embodiments, the OLTC provides discrete tap positions that facilitate incremental voltage regulation of 0.8% to 2.5% per step, compensating for load variations and minimizing voltage deviations without interrupting service.

### Experimental Results and Additional Examples

A study was conducted to develop and evaluate two experimental systems, including a first experimental system (a converter-converter-based system, “GridFormer”) and a second experimental system (an inverter-based system, “GridFirmer”), as described in relation to FIGS. 1-4.

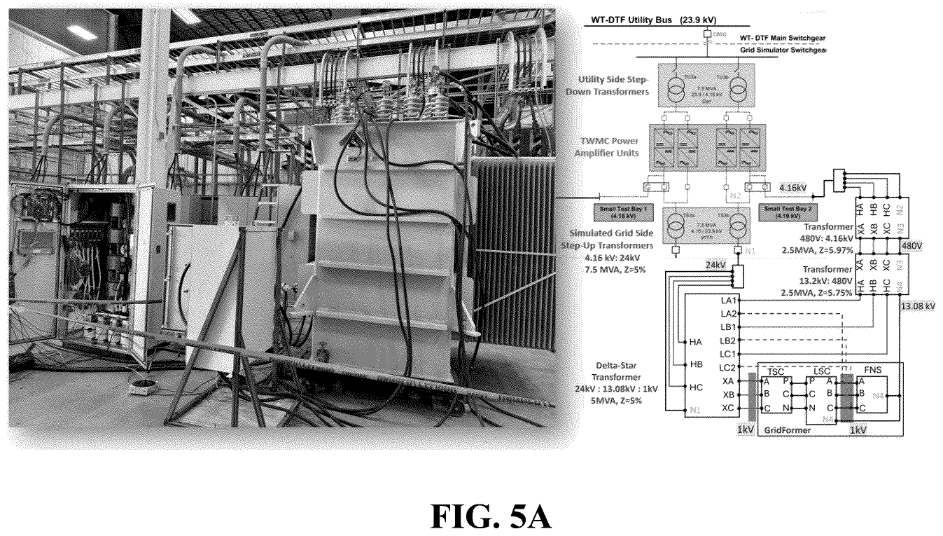

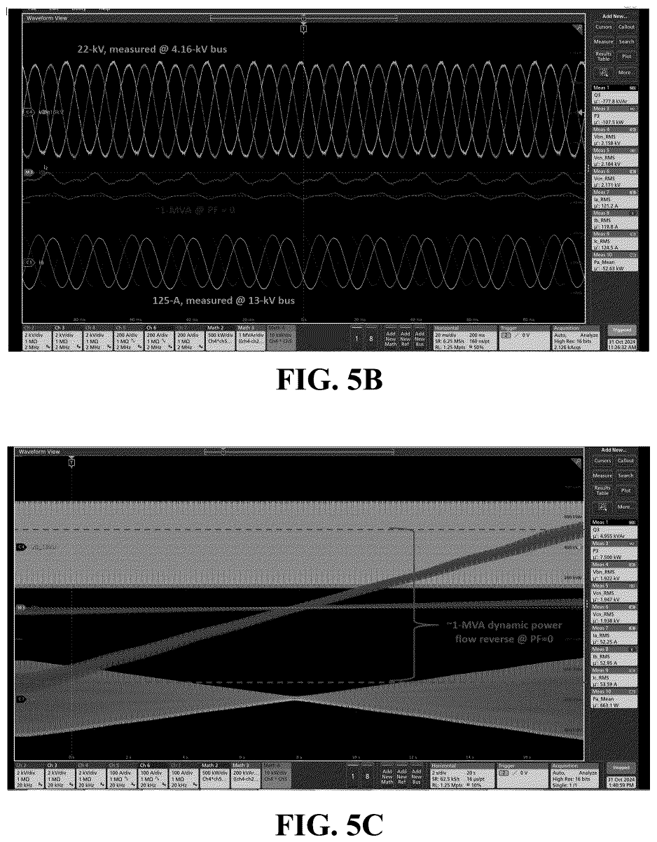

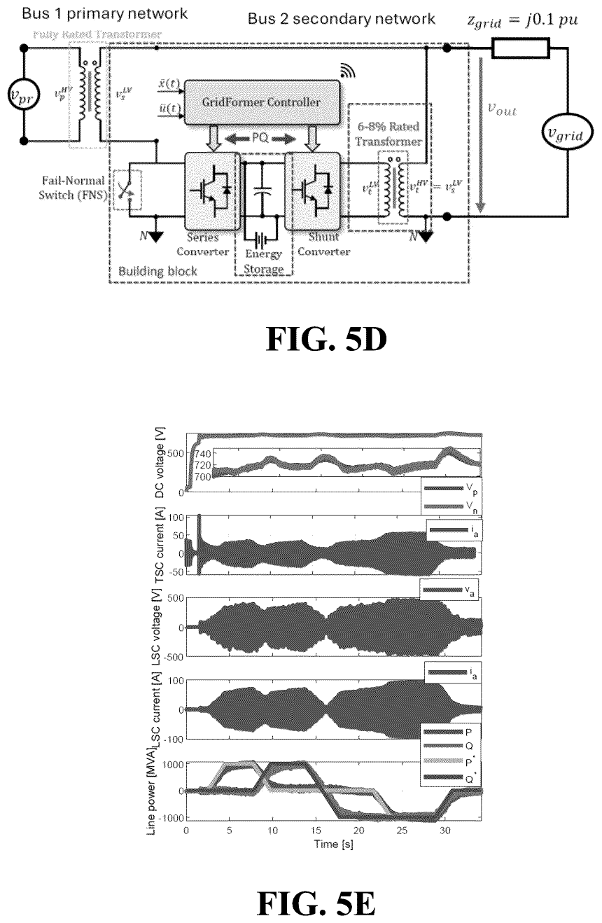

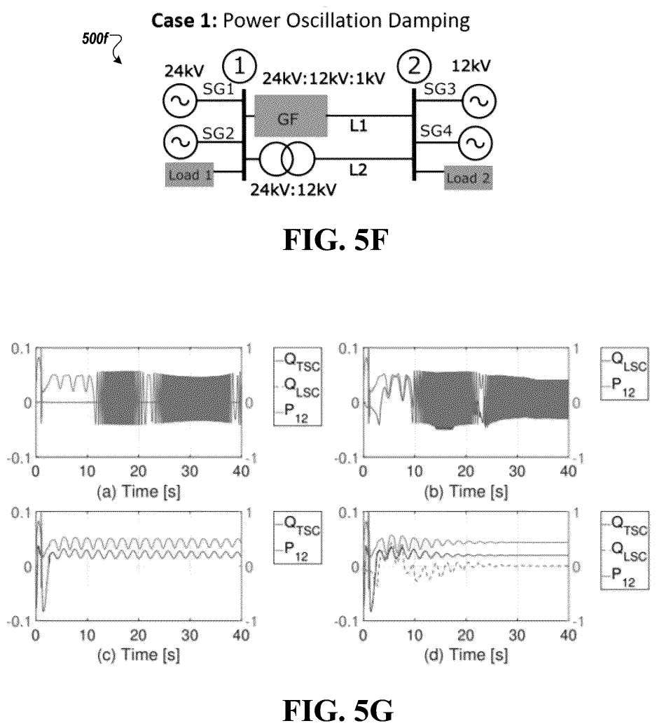

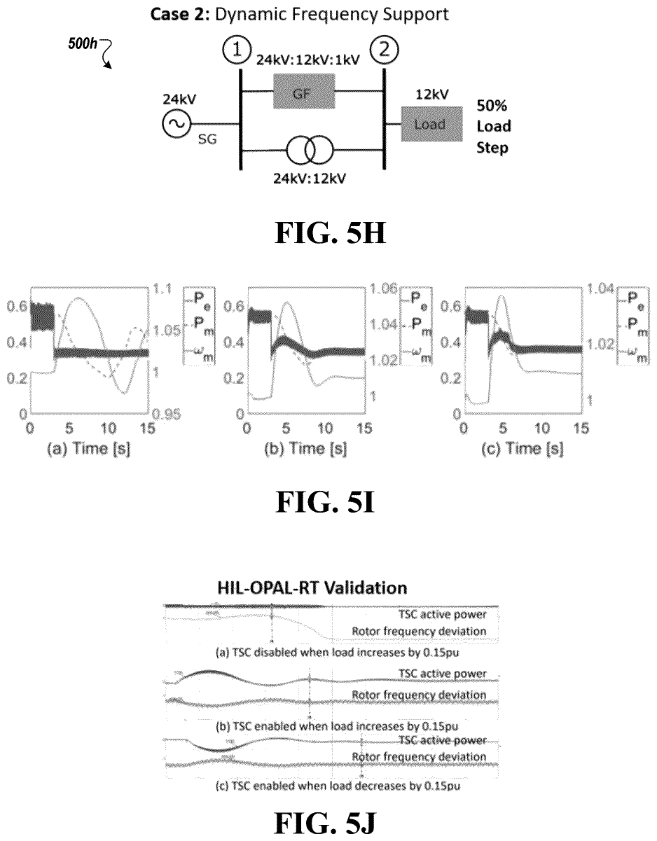

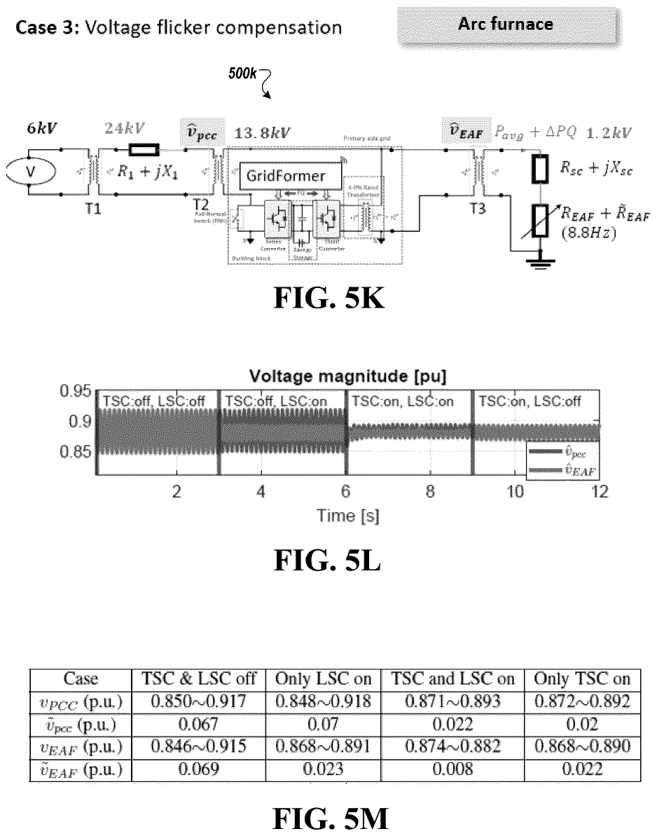

FIG. 5A shows a setup to evaluate the first experimental system and an associated electrical schematic of the setup. As shown, the first experimental system (“GridFormer”) was operatively coupled to a 5-MW, 24/12-kV power grid (also referred to as eGrid).

FIGS. 5B-5C show validation and testing results of the power grid (“eGrid”) before the evaluation of the first experimental system.

FIG. 5D shows a schematic of the power grid (“eGrid”) in the study, into which the first experiment device was retrofitted.

FIG. 5E shows the simulated evaluation results for the first experimental device, which demonstrates its power flow control capability. As shown, the first experimental device injected, via its series converter, voltages between 0 and 8% of the transformer rated voltage with any arbitrary phase. The 8% series voltage injected gave the first experimental device 100% power flow control (MVA).

FIG. 5F shows an experimental circuit 500f. FIG. 5G shows the series/damping performed by the first experimental device in the circuit 500f. As shown, the first experimental device damped a 0.9 pu power oscillation with fractionally rated converters (16%).

FIG. 5H shows an experimental circuit 500h. FIGS. 5I-5J show the dynamic frequency support that the first experimental device provided the circuit 500h with, using a fractionally rated energy storage.

FIG. 5K shows a circuit 500k for an arc furnace. FIGS. 5L-5M show a voltage flicker compensation performed by the first experimental device in the arc furnace 500k. As shown, the first experimental device reduced (i) the point of common coupling (PCC) voltage flicker from 6.7% to 2.2%, and (ii) the arc furnace voltage flicker from 6.9% to 0.8%.

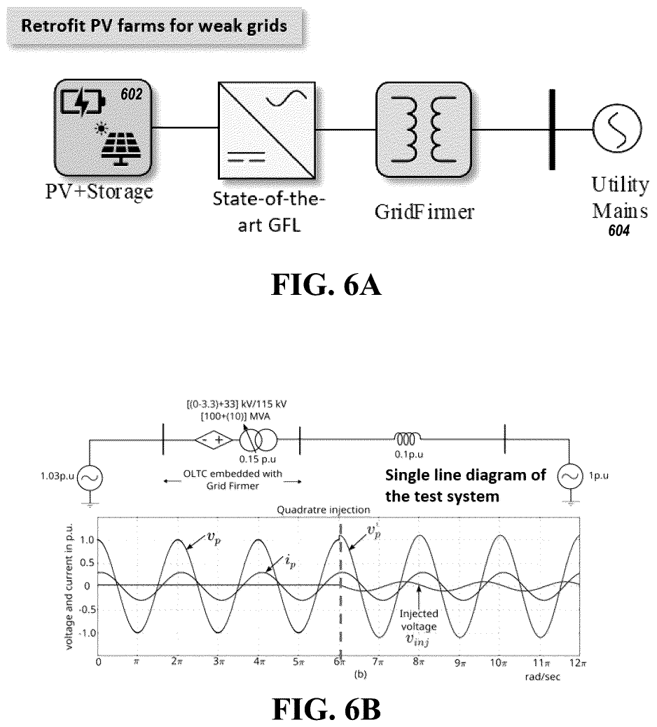

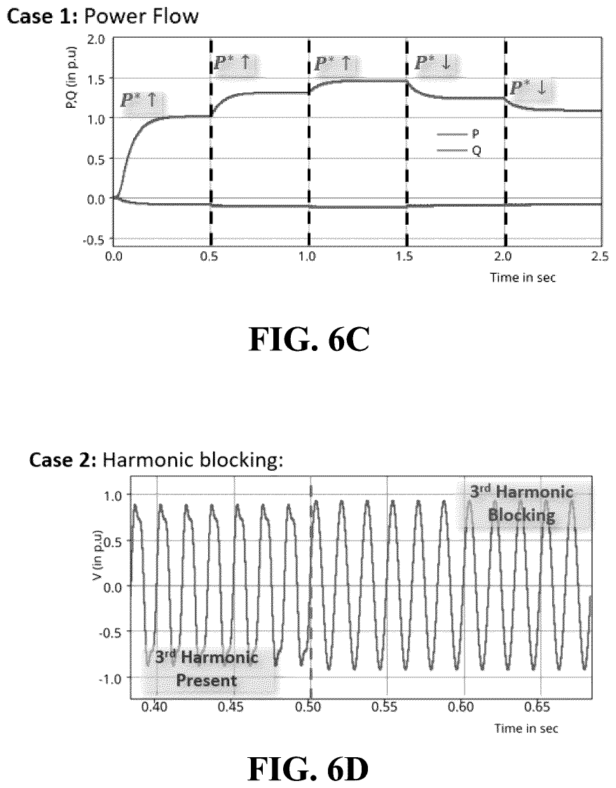

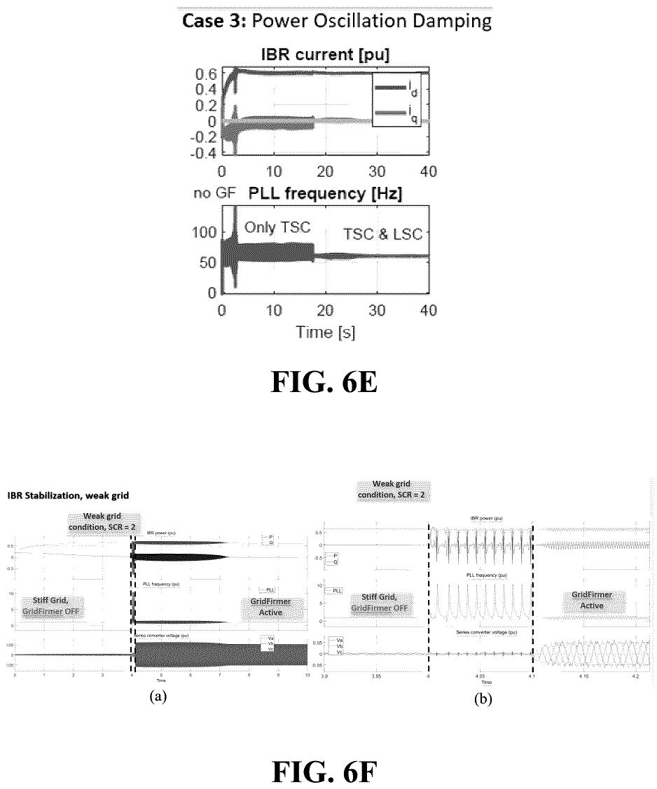

FIG. 6A shows a setup to evaluate the second experimental system. As shown, the second experimental system (“GridFirmer”) was operatively coupled to a weak grid powered by a photovoltaic (PV) plant 602 and utility mains 604.

FIG. 6B shows a schematic of the second experimental system and quadrature voltage injection into the line current of the grid by the second experimental system.

FIG. 6C shows a power flow controlled by the quadrature voltage injection from the second experimental system. As shown, the injected voltage varied between 0 per-unit and 1 per-unit (0 p.u and 1 p.u) (e.g., based on a reference power of 10 MVA and a reference voltage of 3.3 kV) to control the power flow in the grid lines.

FIG. 6D shows a third-harmonic blocking in the grid line, caused by the second experimental system. As shown, the second experimental device was configured to inject 0.15 p.u third-harmonic voltage (in addition to fundamental quadrature voltage injection) to compensate for the third-harmonic component in the grid line. When t<0.5 sec, the line voltage was seen with a third-harmonic component, and when t>0.5, with the activation of the second experimental system, the third-harmonic component was compensated.

FIG. 6E shows power oscillation damping in the grid line caused by the second experimental system. Weak grid conditions degraded the GFL IBR plant performance, causing large phase-locked loop (PLL) oscillations, translating into active power-reactive power (PQ) oscillations in the grid and grid lines. The second experimental device reduced the impedance at the point of common coupling (PCC), thus stabilizing and improving the plant's performance.

FIG. 6F shows the IBR stabilization effect of the second experimental device on the weak grid.

### Additional Discussion

The rapid growth of Inverter-Based Resources (IBRs) on the power grid is creating a challenge in control and stability of the new grid, especially under high IBR penetration conditions. With 100s of gigawatts of new IBRs being deployed and 2600 GW of new resources in the interconnection queue, utility infrastructure is rapidly moving to a grid that may increasingly be powered by variable resources such as wind and PV solar. This intermittency can cause issues on the grid, including voltage fluctuations, congestion on meshed grids, the need to damp oscillations due to interactions, and instability of IBRs with weak grids. In principle, designing IBRs to mitigate such problems may be possible. However, the technology for such IBRs is in its infancy, and the availability of proven mature IBR solutions may take decades, by which time, 1000s of GWs of currently available IBRs may have been deployed. These challenges slow the adoption of IBRs and the transition to a clean, decarbonized energy system.

An approach is needed that can use mature, proven low-risk hardware solutions to augment the current grid, allowing the deployment of 1000+ GW of IBRs to be rolled out quickly. A solution may be retrofitted onto current grid assets and achieve the desired grid behavior, allowing sufficient time for the new IBRs to be developed, standardized, and available at scale. This has to be a low-cost solution that can be rolled out and may not degrade the performance of the current grid to below its current levels under normal, abnormal, and fault conditions. The solution should be cost-effective and deployable at scale over a wide range of power ratings, from transmission systems at 130 kVAC to 500 kVAC to distribution systems at 115 kVAC to 13 kVAC, covering power levels of 1 MW to 200+ MW. Of particular importance in this new grid capability are the attributes of voltage regulation, power flow control, damping for grid-stabilization, and grid-firming to allow current GFL IBRs to continue to operate without degradation and capacity limits.

As PV solar and battery storage prices continue declining, there are 2,600 GW (2.5× of current capacity), 95% of which are inverter-based resources, waiting to connect to the grid. Most current inverters are of the grid-following (GFL) type, and struggle with weak grids or at high IBR penetration levels. As IBR deployment increases, there is a need to improve grid utilization and stability. However, there is a 10-15-year lag in the standards process by which newer grid-inverter control technologies that are being developed, such as grid-forming (GFM) inverters, can be deployed at scale. Over 1,000 GW of non-compliant inverters may have been deployed during this time. Even China, with 1,100 GW of IBRs on the grid, faces challenges in keeping the grid stable.

Transmission and distribution system operators face the limited capacity of current AC lines and may not permit the integration of growing renewables at remote locations. Due to grid-stability concerns, electricity utilities may not allow feeding the regenerative energy and operate under fault conditions (inertia). Load and renewable generation prediction may worsen since fast charging stations may generate high demand peaks. This should warn that the U.S. grid may see similar issues as IBR penetration increases.

The exemplary system is developed to augment the current grid using mature, proven hardware to realize advanced functionality, such as power-flow control, dynamic voltage regulation, harmonic reduction, and grid stabilization. The exemplary system can be retrofitted into current grid assets to improve grid utilization, reduce the new transmission needed for distributed energy resources (DERs), and help stabilize the grid as IBRs are rolled out at scale.

Example embodiments, that are not limiting of this disclosure, include FIG. 1A in which a system is configured to couple to a power grid, the system comprising a transformer 104 having a primary winding 25 and a secondary winding 28, wherein the secondary winding is operatively connected to the power grid 108; a conversion circuit 102 having a first circuit end 50 and a second circuit end 55, the first circuit end 50 being operatively connected to the power grid 108, the second circuit end 55 being operatively connected to the primary winding 25. The conversion circuit comprises a first converter 114 located at the first circuit end 55; a second converter 120 operatively coupled to the first converter 114; and a controller 112 operatively coupled to the first converter 114 and the second converter 120. The controller may be configured to receive, via the first converter, from the power grid, a first line current 110 having a first voltage value and a first power value; inject, via the first converter 114, a controllable voltage into the first line current 110, to cause a change in the first voltage value and the first power value, thereby generating a second line current 116 having a second voltage value and a second power value; adjust, via the second converter 120, magnitudes of the second voltage value and the second power value within operational ranges of the power grid 108; and transmit, via the second converter, the second line current, through the primary winding 25 and the secondary winding 28, to reach the power grid. In other non-limiting embodiments, the conversion circuit further comprises an energy storage 118, operatively coupled to the first converter 114 and the second converter 120, the energy storage being configured to store the second line current 116, or power thereof. The system may further include a fail-normal switch (FNS) 124 configured to respond to a line fault or a fault inside the conversion circuit and allow the first line current 110 to bypass the conversion circuit. The transformer 104 may be fractionally rated as disclosed herein. The first converter 114 may be a series converter, and wherein the first converter may be further configured to provide a series damping for oscillations in the first line current. The second converter 120 may be a shunt converter, and wherein the second converter is further configured to provide a shunt damping for oscillations in the second line current. In non-limiting embodiments, the second line current has lower frequency harmonics than the first line current and the controllable voltage may be a series voltage. The system may include an on-load tap charger (OLTC) 106 operatively coupled to the secondary winding 28 of the transformer and the power grid, the OLTC being configured to adjust output voltage at the secondary winding while the transformer is energized and under a load.

As shown in FIG. 1B, and without limiting this disclosure in any way, a system is disclosed to couple to a power grid 108. The system may include a transformer 104 having a primary winding 35 and a secondary winding 38, wherein the secondary winding is operatively coupled to the power grid and a ground. A conversion circuit according to this embodiment may be described according to a first circuit end 50 and a second circuit end 55, the first circuit end being operatively coupled to the power grid, the second circuit end being operatively coupled to the primary winding 35. In non-limiting embodiments, the conversion circuit may include a converter 114 located at the first circuit end; an inverter 130 operatively coupled to the converter; and a controller 112 operatively coupled to the converter and the inverter. The conversion circuit is configured to receive, via the converter 114, from the power grid 108, a first line current 110 having a first voltage value and a first power value. The conversion circuit injects, via the converter 114, a first controllable voltage into the first line current 110, to cause a change in the first voltage value and the first power value, thereby generating a second line current 11 having a second voltage value and a second power value. The conversion circuit 102 injects, via the inverter 130, a second controllable voltage into the second line current 116, to cause a change in the second voltage value and the second power value, thereby generating a third line current 132 having a third voltage value and a third power value within operational ranges of the power grid 108. The conversion circuit then transmits, via the inverter 130, the third line current, through the primary winding 35 and the secondary winding 38, to reach the power grid. The third line current 132 may have been modified by either or both of the converter 114 or the inverter 130, as the controller 112 determines which outputs from either or both of the converter 114 or the inverter 130 are necessary to maintain control of the grid.

In other non-limiting embodiments, the system comprises a fail-normal switch (FNS) configured to, in response to a line fault or a fault inside the conversion circuit, allow the first line current or the third line current to reach a ground terminal, thereby bypassing the conversion circuit. The system may include attaching the conversion circuit 102 to an on-load tap charger (OLTC) operatively coupled to the secondary winding of the transformer and the power grid, the OLTC being configured to adjust output voltage at the secondary winding while the transformer is energized and under load. In some embodiments, the conversion circuit 102 is connected to a neutral line connection of the OLTC. The transformer may be fractionally rated. The inverter may be a photovoltaic inverter. The first controllable voltage is a series voltage. The second controllable voltage is a quadrature voltage configured to be injected into each phase of each frequency harmonic within the second line current.

As shown in FIG. 1C, and without limitation, a system of this disclosure may be configured to couple to a power grid and include a transformer 104 having a primary winding 45 and a secondary winding 48, wherein the secondary winding is operatively coupled to the power grid 108 and a ground; a conversion circuit of this embodiment may be described according to a first circuit end 50 and a second circuit end 55, the first circuit end being operatively coupled to the power grid 108, the second circuit end being operatively coupled to the primary winding 45. The conversion circuit may include an inverter 130 located at the first circuit end, and a controller 112 may be operatively coupled to the inverter, with the controller being configured to receive, via the inverter, from the power grid, a first line current having a first voltage value and a first power value. The conversion circuit injects, via the inverter, a controllable voltage into the first line current 110, to cause a change in the first voltage value and the first power value, thereby generating a second line current 140 having a second voltage value and a second power value within operational ranges of the power grid; and transmit, via the inverter, the second line current 140, through the primary winding 45 and the secondary winding 48, to reach the power grid. The system includes a fail-normal switch (FNS) configured to respond to a line fault or a fault inside the conversion circuit and allow the first line current or the second line current to reach a ground terminal, thereby bypassing the conversion circuit. In some embodiments, an on-load tap charger (OLTC) is operatively coupled to the secondary winding of the transformer and the power grid, the OLTC being configured to adjust output voltage at the secondary winding while the transformer is energized and under load. The inverter may be a photovoltaic inverter.

### CONCLUSION

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense but for explanatory purposes. For purposes of this disclosure, the term “coupled” means the joining of two components (electrical, mechanical, magnetic, or by data communication) directly or indirectly to one another. To be operatively coupled, the joining may include intermediate components. Such joining may be stationary in nature or movable in nature. Such joining may be achieved with the two components (electrical or mechanical) and any additional intermediate members being integrally defined as a single unitary body with one another or with the two components or the two components and any additional member being attached to one another or in communication with one another. Such joining may be permanent in nature or alternatively may be removable or releasable in nature

Disclosed are components that can be used to perform the disclosed methods and systems. These and other components are disclosed herein, and it is understood that when combinations, subsets, interactions, groups, etc. of these components are disclosed while specific reference of each various individual and collective combinations and permutation of these may not be explicitly disclosed, each is specifically contemplated and described herein, for all methods and systems. This applies to all aspects of this application, including, but not limited to, steps in disclosed methods. Thus, if there are a variety of additional steps that can be performed, it is understood that each of these additional steps can be performed with any specific implementation or combination of implementations of the disclosed methods.

The following patents, applications, and publications, as listed below and throughout this document, are hereby incorporated by reference in their entirety herein.

### REFERENCE LIST

[1] https://wiki.testguy.net/t/transformer-tap-changers-basic-principles-and-testing-explained/63
[2] On-load Tap Changer (OLTC) Market Size and Share Analysis 2024:-SOUTHEAST-NEWS CHANNEL NEBRASKA
[3] H. Zhao, M. Hong, W. Lin, and K. A. Loparo, “Voltage and Frequency Regulation of Microgrid With Battery Energy Storage Systems,” in IEEE Transactions on Smart Grid, vol. 10, no. 1, pp. 414-424, January 2019.
[4] S. A. Pourmousavi and M. H. Nehrir, “Real-Time Central Demand Response for Primary Frequency Regulation in Microgrids,” in IEEE Transactions on Smart Grid, vol. 3, no. 4, pp. 1988-1996 December 2012.
[5] D. Yan, J. Benzaquen and D. Divan, “GridFormer—A New Approach to Stabilize and Manage a High IBR Penetration Grid,” 2023 IEEE Energy Conversion Congress and Exposition (ECCE), Nashville, TN, USA, 2023, pp. 1096-1103.

What is claimed:

1. A system configured to couple to a power grid, the system comprising:
a transformer having a primary winding and a secondary winding, wherein the secondary winding is operatively connected to the power grid;
a conversion circuit having a first circuit end and a second circuit end, the first circuit end being operatively connected to the power grid, the second circuit end being operatively connected to the primary winding, the conversion circuit comprising:
a first converter located at the first circuit end;
a second converter operatively coupled to the first converter; and
a controller operatively coupled to the first converter and the second converter, the controller being configured to:
receive, via the first converter, from the power grid, a first line current having a first voltage value and a first power value;
inject, via the first converter, a controllable voltage into the first line current, to cause a change in the first voltage value and the first power value, thereby generating a second line current having a second voltage value and a second power value;
adjust, via the second converter, magnitudes of the second voltage value and the second power value within operational ranges of the power grid; and
transmit, via the second converter, the second line current, through the primary winding and the secondary winding, to reach the power grid.

2. The system of claim 1, wherein the conversion circuit further comprises:
an energy storage, operatively coupled to the first converter and the second converter, the energy storage being configured to store the second line current, or power thereof.

3. The system of claim 1, further comprising a fail-normal switch (FNS) configured to:
in response to a line fault or a fault inside the conversion circuit, allow the first line current to bypass the conversion circuit.

4. The system of claim 1, wherein the transformer is fractionally rated.

5. The system of claim 1, wherein the first converter is a series converter, and wherein the first converter is further configured to provide a series damping for oscillations in the first line current.

6. The system of claim 1, wherein the second converter is a shunt converter, and wherein the second converter is further configured to provide a shunt damping for oscillations in the second line current.

7. The system of claim 1, wherein the second line current has lower frequency harmonics than the first line current.

8. The system of claim 1, wherein the controllable voltage is a series voltage.

9. The system of claim 1, further comprising:
an on-load tap charger (OLTC) operatively coupled to the secondary winding of the transformer and the power grid, the OLTC being configured to adjust output voltage at the secondary winding while the transformer is energized and under load.

10. A system configured to couple to a power grid, the system comprising:
a transformer having a primary winding and a secondary winding, wherein the secondary winding is operatively coupled to the power grid and a ground;
a conversion circuit having a first circuit end and a second circuit end, the first circuit end being operatively coupled to the power grid, the second end being operatively coupled to the primary winding, the conversion circuit comprising:
a converter located at the first circuit end;
an inverter operatively coupled to the converter; and
a controller operatively coupled to the converter and the inverter, the controller being configured to:
receive, via the converter, from the power grid, a first line current having a first voltage value and a first power value;
inject, via the converter, a first controllable voltage into the first line current, to cause a change in the first voltage value and the first power value, thereby generating a second line current having a second voltage value and a second power value;
inject, via the inverter, a second controllable voltage into the second line current, to cause a change in the second voltage value and the second power value, thereby generating a third line current having a third voltage value and a third power value within operational ranges of the power grid; and
transmit, via the inverter, the third line current, through the primary winding and the secondary winding, to reach the power grid.

11. The system of claim 10, further comprising a fail-normal switch (FNS) configured to:
in response to a line fault or a fault inside the conversion circuit, allow the first line current or the third line current to reach a ground terminal, thereby bypassing the conversion circuit.

12. The system of claim 10, further comprising:
an on-load tap charger (OLTC) operatively coupled to the secondary winding of the transformer and the power grid, the OLTC being configured to adjust output voltage at the secondary winding while the transformer is energized and under load.

13. The system of claim 10, wherein the transformer is fractionally rated.

14. The system of claim 10, wherein the inverter is a photovoltaic inverter.

15. The system of claim 10, wherein the first controllable voltage is a series voltage.

16. The system of claim 10, wherein the second controllable voltage is a quadrature voltage configured to be injected into each phase of each frequency harmonic within the second line current.

17. A system configured to couple to a power grid, the system comprising:
a transformer having a primary winding and a secondary winding, wherein the secondary winding is operatively coupled to the power grid and a ground;
a conversion circuit having a first circuit end and a second circuit end, the first circuit end being operatively coupled to the power grid, the second end being operatively coupled to the primary winding, the conversion circuit comprising:
an inverter located at the first circuit end; and
a controller operatively coupled to the inverter, the controller being configured to:
receive, via the inverter, from the power grid, a first line current having a first voltage value and a first power value;
inject, via the inverter, a controllable voltage into the first line current, to cause a change in the first voltage value and the first power value, thereby generating a second line current having a second voltage value and a second power value within operational ranges of the power grid; and
transmit, via the inverter, the second line current, through the primary winding and the secondary winding, to reach the power grid.

18. The system of claim 17, further comprising a fail-normal switch (FNS) configured to:
in response to a line fault or a fault inside the conversion circuit, allow the first line current or the second line current to reach a ground terminal, thereby bypassing the conversion circuit.

19. The system of claim 17, further comprising:
an on-load tap charger (OLTC) operatively coupled to the secondary winding of the transformer and the power grid, the OLTC being configured to adjust output voltage at the secondary winding while the transformer is energized and under load.

20. The system of claim 17, wherein the inverter is a photovoltaic inverter.
